(19) United States
(12) Patent Application Publication
(10) Pub. No.: US 2018/0053254 A1
(43) Pub. Date: Feb. 22, 2018

(54) Method of providing the functionality of an exotic option contract by using an algorithmic index as the underlying reference of a standard Vanilla option contract

(71) Applicant: Jane Koo, San Francisco, CA (US)

(72) Inventor: Jane Koo, San Francisco, CA (US)

(21) Appl. No.: 15/238,647

(22) Filed: Aug. 16, 2016

(51) Int. Cl. G06Q 40/06

(52) U.S. Cl. CPC G06Q 40/06

(57) ABSTRACT

A method of providing the functionality of an exotic option contract including the steps of: providing an algorithmic index; providing a standard “Vanilla” option contract; and using the algorithmic index as the underlying reference of the standard “Vanilla” option contract so that the payoff of the standard “Vanilla” option contract would be identical or substantially similar to the payoff of an exotic option contract.

### FIELD OF THE INVENTION

The present invention generally relates to systems and methods for providing the functionality of an exotic option, and in particular to systems and methods for providing an algorithmic index; providing a standard “Vanilla” option contract; and using the algorithmic index as the underlying reference of the standard “Vanilla” option contract so that the payoff of the standard “Vanilla” option contract would be identical or substantially similar to the payoff of an exotic option contract.

### BACKGROUND OF THE INVENTION

Standard “Vanilla” option contracts such as call options and put options with European style exercise or American style exercise often cannot help investors achieve their investment objectives or pursue their investment strategies. Instead of the payout of a standard “Vanilla” option contract, these investors would need the functionality of an “exotic” option contract. “Exotic” option is a generic name referring to an option contract that is not a standard “Vanilla” option contract. Common types of “exotic” options include (but are not limited to) “Rainbow Options” and “Barrier Options”. The payout of a “Rainbow Option” generally depends on one or some of the assets in an underlying reference basket of multiple assets, such as the “Best Performing” asset or the “Worst Performing” asset in an underlying reference basket of multiple assets, commonly known as a “Best-Of” option or “Worst-Of” option respectively. The payout of a “Barrier Option” is generally a pre-determined dollar amount if the value of the underlying reference asset reaches a particular level (the “Barrier”). The Barrier of some Barrier Options are observed continuously (e.g. observed daily at the market close) or only at the option's expiration. Typical Barrier Options include “Knock-Out” Options, “Knock-In” Options, and “Binary” (or “Digital”) Options.

If the investors want to get, for instance, the performance of only the best performing asset or only the worst performing asset of an underlying basket of reference assets, the investors would need the “exotic” functionality of a “Best-Of” Option or a “Worst-Of” Option respectively. However, such exotic option contracts are often not available on public option exchanges. Also, even when these exotic option contracts are available in non-exchange traded markets (such as “over-the-counter” or “OTC” options), the description of the payoff of these exotic option contracts are much more complicated than the description of the payoff of standard “Vanilla” option contracts such as call options and put options with European style exercise or American style exercise. The simplification of the description of the payoff of the option contract and the ability to trade such option contract on a public option exchange are often two of the most important criteria required by the investors.

Accordingly, there is a need for a method of providing a system and method to effectively provide the functionality of an exotic option contract (the “Target Exotic Option”) by providing an algorithmic index (the “Algorithmic Index”); providing a standard “Vanilla” option contract (the “Vanilla Option”); and using the Algorithmic Index as the underlying reference of the Vanilla Option so that the payoff of the Vanilla Option would be identical or substantially similar to the payoff of the Target Exotic Option. The Vanilla Option referencing such Algorithmic Index would simplify the description of the payoff of the option contract and also significantly facilitate such option contract to be traded on a public option exchange.

### DESCRIPTION OF THE RELATED ART

Certain aspects of the current invention's three steps of (a) providing an algorithmic index, (b) providing a standard “Vanilla” option contract, and (c) using the algorithmic index as the underlying reference of the standard “Vanilla” option contract so that the payoff of the standard “Vanilla” option contract would be identical or substantially similar to the payoff of an exotic option contract are known in the art. However, prior art regarding “algorithmic index” only focused on the design of certain specific algorithmic indices for certain investment objectives or strategies, such as combining investment in equities and investment in “investable volatility” to potentially reduce the risk of equity investment. Prior art regarding “exotic option” only focused on the pricing and trading aspects of certain specific exotic options. Prior art applications, therefore, do not provide a solution so an investor can use a standard “Vanilla” option contract referencing an “algorithmic index” where the “algorithmic index” is specifically designed so the standard “Vanilla” option contract referencing such index would have a payoff identical or substantially similar to the payoff of a desired “exotic” option contract, and thereby significantly simplifying the description of the payoff of the option contract (as the payoff of a standard “Vanilla” option contract is generally much less complicated than the payoff of an “exotic” option contract) and also facilitating such an option contract to be traded on a public option exchange (as most public option exchanges do not list most exotic option contracts).

Moreover, the current invention is a solution for the functionality of all kinds of “exotic” option contracts based on all kinds of different investment objectives or strategies by using the appropriately designed “algorithmic index” in each different case, instead of focusing on the design of a certain specific algorithmic index for a certain specific investment objective or strategy (like combining equities and “investable” volatility). Also the goal of the current investment is to simplify the description of the option payoff of all kinds of “exotic” option contracts and to facilitate such option contracts to be traded on a public option exchange, instead of focusing on the pricing and trading aspects of only certain specific exotic options.

### SUMMARY OF THE INVENTION

A method of providing the functionality of an exotic option contract (the “Target Exotic Option”) comprises the steps of: providing an algorithmic index (the “Algorithmic Index”); providing a standard “Vanilla” option contract (the “Vanilla Option”) such as (but not limited to) an exchange traded or OTC call option or put option with European style exercise or American style exercise; and using the Algorithmic Index as the underlying reference of the Vanilla Option so that the payoff of the Vanilla Option would be identical or substantially similar to the payoff of the Target Exotic Option such as but not limited to a “Best-Of” or “Worst-Of” call or put option contract.

According to an exemplary embodiment of the present invention, a computer system for providing the Algorithmic Index; providing the Vanilla Option; and using the Algorithmic Index as the underlying reference of the Vanilla Option so that the payoff of the Vanilla Option would be identical or substantially similar to the payoff of the Target Exotic Option comprises: a memory that stores data relating to the Algorithmic index, the Vanilla Option and the Target Exotic Option; a computer-readable medium comprising: an instrument calculator that determines values of the Algorithmic Index, the Vanilla Option and the Target Exotic Option.

In at least one embodiment, the Target Exotic Option belongs to a category of options generally known as “Rainbow Options” such as but not limited to “Best-Of” options and “Worst-Of” options.

In at least one embodiment, the Target Exotic Option belongs to a category of options generally known as “Barrier Options” such as but not limited to options with “Knock-Out” or “Knock-In” Barriers observed continuously or at expiration, or Binary Options (also known as “Digital Options”) with Barriers observed continuously or at expiration.

In at least one embodiment, the Target Exotic Option is a combination of different categories of exotic options such as but not limited to a Binary Option referencing the “Worst Performing” asset in an underlying reference basket of multiple assets.

These and other features of this invention are described in, or are apparent from, the following detailed description of various exemplary embodiments of this invention.

### BRIEF DESCRIPTION OF THE DRAWINGS

Various exemplary embodiments of this invention will be described in detail, with reference to the following figures, wherein:

FIG. 1 is a flowchart showing a method of providing the functionality of an exotic option contract according to an exemplary embodiment of the present invention; and

FIG. 2 is a block diagram of a system of providing the functionality of an exotic option contract according to an exemplary embodiment of the present invention.

### DETAILED DESCRIPTION OF PREFERRED EMBODIMENTS

By using the Algorithmic Index and the Vanilla Option, the present invention is able to provide the functionality of the Target Exotic Option by the Vanilla Option referencing the Algorithmic Index. In particular, according to the present invention, the Algorithmic Index is designed so that the payoff of the Vanilla Option (which references the Algorithmic Index) would be identical or substantially similar to the payoff of the Target Exotic Option. For instance, an Algorithmic Index can be designed so the daily closing level of the Algorithmic Index would be the daily closing level of only the “Best Performing” asset of the underlying reference basket of multiple assets. The payoff of the Vanilla Option referencing this Algorithmic Index would then be identical to the payoff of a comparable “Best-Of” Option on the same underlying reference basket of multiple assets. Another example would be using an Algorithmic Index designed in such a way so that the value of the Algorithmic Index would be a pre-determined number if the daily closing value of an underlying reference asset reaches a particular level (the “Barrier”). The payoff of the Vanilla Option referencing this Algorithmic Index would then be identical to a comparable Barrier Option on the same underlying reference asset.

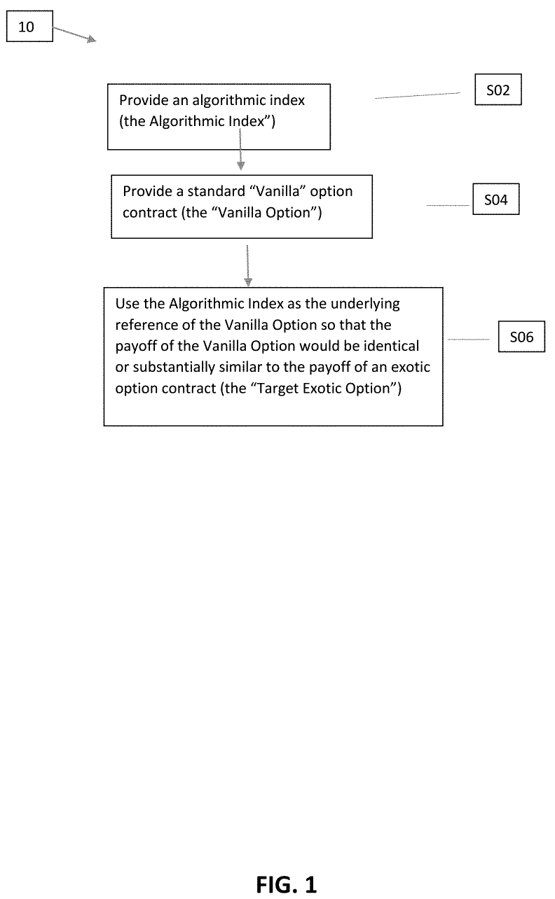

FIG. 1 is a flowchart showing a method, generally designated by reference number 10, of providing the functionality of an exotic option contract according to an exemplary embodiment of the present invention. In step S02 of the method 10, an algorithmic index (the Algorithmic Index”) is provided to be used as an underlying reference. In step S04 of the method 10, a standard “Vanilla” option contract (the “Vanilla Option”) is provided. Examples of such Vanilla Option include but are not limited to exchange traded or OTC call option or put option with European style exercise or American style exercise.

In step S06 of the method 10, the Vanilla Option references the Algorithmic Index so that the payoff of the Vanilla Option is identical or substantially similar to the payoff of a desired exotic option contract (the “Target Exotic Option”). Examples of such Target Exotic Option include but are not limited to Rainbow Options, Barrier Options, combination of Rainbow Option and Barrier Options, etc.

### Example 1

An Algorithmic Index is provided so that the daily closing level of the Algorithmic Index is the Best Performing (or Worst Performing) asset of an underlying reference asset of multiple assets. A Vanilla Option references the Algorithmic Asset so that the payoff of the Vanilla Option is identical to the payoff of a comparable “Best-Of” (or “Worst-Of”) option contract referencing the same underlying reference basket (the “Target Exotic Option” in this example).

### Example 2

An Algorithmic Index is provided so that the daily closing level of the Algorithmic Index is a pre-determined value (e.g. zero) if the daily closing value of the underlying reference asset reaches a particular level (the “Barrier”). A Vanilla Option references the Algorithmic Asset so that the payoff of the Vanilla Option is identical to the payoff of a comparable “Barrier” option contract referencing the same underlying reference basket (the “Target Exotic Option” in this example).

### Example 3

An Algorithmic Index is provided so that the daily closing level of the Algorithmic Index is a pre-determined value (e.g. zero) if the daily closing value of the “Best Performing” asset of the underlying reference basket of multiple assets reaches a particular level (the “Barrier”). A Vanilla Option references the Algorithmic Asset so that the payoff of the Vanilla Option is identical to the payoff of a comparable “Barrier Best-Of” option contract referencing the same underlying reference basket (the “Target Exotic Option” in this example).

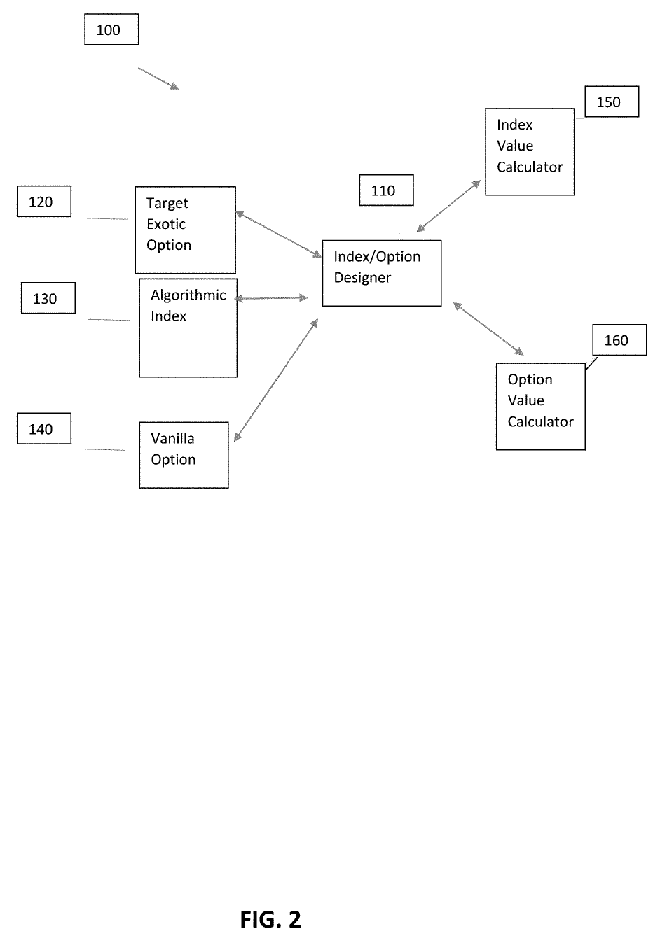

FIG. 2 is a block diagram of a system, generally designated by reference number 100, of providing the functionality of an exotic option contract according to an exemplary embodiment of the present invention. The system 100 includes the Index/Option Designer 120 who designs the Algorithmic Index 130 based on the desired payoff function of the Target Exotic Option 120 and the payoff function of the Vanilla Option 140.

The Index Value Calculator 150 determines the values of the Algorithmic Index and the Option Value Calculator 160 determines the values of the Vanilla Option (which references the Algorithmic Index) and the values of the Target Exotic Option (which uses a comparable underlying reference). The objective of the Index/Option Designer is to achieve the result of the Vanilla Option and the Target Exotic Option having identical or substantially similar values.

While this invention has been described in conjunction with the exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

1. A method of providing the functionality of an exotic option, the method comprising: providing an algorithmic index (the “Algorithmic Index”); providing a standard “Vanilla” option contract (the “Vanilla Option”); and using the Algorithmic Index as the underlying reference of the Vanilla Option so that the payoff of the Vanilla Option would be identical or substantially similar to the payoff of an exotic option contract (the “Target Exotic Option”).

2. The method of claim 1, wherein the Target Exotic Option includes an option contract that is a “Rainbow Option” (such as but not limited to a “Best-Of” option or “Worst-Of” option.)

3. The method of claim 1, wherein the Target Exotic Option includes an option contract that is not a “Rainbow Option”.

4. The method of claim 1, wherein the Target Exotic Option includes an option contract that is a “Barrier Option” (such as but not limited to “Knock-Out” Option or “Knock-In” Option with Barrier observed continuously or at expiration, a Barrier or Digital Option with Barrier observed continuously or at expiration)

5. The method of claim 1, wherein the Target Exotic Option includes an option contract that is not a “Barrier Option”.

6. The method of claim 1, wherein the Target Exotic Option includes an option contract that is a combination of a “Rainbow Option” and a “Barrier Option” (such as but not limited to “Knock-Out” Option or “Knock-In” Option with Barrier observed continuously or at expiration referencing the “Best Performing” or “Worst Performing” asset in an underlying reference basket of multiple assets, a Barrier or Digital Option with Barrier observed continuously or at expiration referencing the “Best Performing” or “Worst Performing” asset in an underlying reference basket of multiple assets).

7. The method of claim 1, wherein the Target Exotic Option includes an option contract that is not a combination of a “Rainbow Option” and a “Barrier Option”.

8. The method of claim 1, wherein the Vanilla Option includes an option contract that is exchange-traded.

9. The method of claim 1, wherein the Vanilla Option includes an option contract that is not exchange-traded (such as but not limited to an “over-the-counter” option or “OTC” option).

10. The method of claim 1, wherein the Vanilla Option includes an option contract that is an option with European style exercise.

11. The method of claim 1, wherein the Vanilla Option includes an option contract that is not an option with European style exercise (such as but not limited to American style exercise, Asian style exercise, Bermudan style exercise).

12. The method of claim 1, wherein the Vanilla Option includes one single option contract.

13. The method of claim 1, wherein the Vanilla Option includes multiple option contracts.

14. The method of claim 1, wherein the Algorithmic Index includes one single index or reference asset.

15. The method of claim 1, wherein the Algorithmic Index includes multiple indices or reference assets.
